(19) United States
(12) Patent Application Publication
(10) Pub. No.: US 2024/0011720 A1
(43) Pub. Date: Jan. 11, 2024

(54) SYSTEM FOR THERMOCHEMICAL STORAGE WITH IMPROVED DEHYDRATION

(71) Applicants: TECHNISCHE UNIVERSITEIT EINDHOVEN, Eindhoven (NL); NEDERLANDSE ORGANISATIE VOOR TOEGEPAST-NATUURWETENSCHAPPELIJK ONDERZOEK TNO, 'S-GRAVENHAGE (NL)

(72) Inventors: Petrus Adrianus Joseph Donkers, Eindhoven (NL); Jelle Houben, Eindhoven (NL); Olaf Clemens Gerardus ADAN, Eindhoven (NL)

(21) Appl. No.: 18/276,625

(22) PCT Filed: Feb. 8, 2022
(86) PCT No.: PCT/NL2022/050063

§ 371 Date: Aug. 9, 2023

(30) Foreign Application Priority Data
Feb. 10, 2021 (NL) 2027536

(51) Int. Cl. F28D 20/00

(52) U.S. Cl. CPC F28D 20/003; F28D 2020/0078

(57) ABSTRACT

The invention is directed to a thermochemical system such as a thermochemical heat battery that can efficiently operate at relative low temperatures. Accordingly, a system for thermochemical storage is provided which system comprises a thermochemical reactor and a water condenser for dehumidifying a gas stream comprising a condensing surface provided with a hygroscopic material.

### FIELD The invention is directed to a system for thermochemical storage and to a method for desorption in such a system

### INTRODUCTION

In conventional thermochemical material (TCM) heat batteries, heat storage in salts should be done at relatively high temperatures (>80° C.). This is for example the case for solar collectors in winter condition or for heating networks (new generation).

To address the requirement for relative high temperatures, existing approaches reduce the number of charging moments in the winter or increase the number of solar collectors.

US 2015/219402 describes a process for storing thermal energy by chemical reaction wherein a flow of heat transfer gas is circulated through a layer of a first hygroscopic salt and then through a layer of a second hygroscopic salt. No water condenser is applied in this process.

WO 2016/036242 describes a closed system for thermochemical storage comprising a water condenser and two thermochemical modules with thermochemical material (e.g. hygroscopic salt). No hygroscopic material is present in the water condenser.

It is an object to provide a thermochemical system such as a thermochemical heat battery that can efficiently operate at relative low temperatures.

### SUMMARY

In one aspect, the invention is directed to a system for thermochemical storage comprising a thermochemical reactor comprising a thermochemical material capable of storing and releasing heat by a thermochemical exchange process under release or binding of water; and a water condenser for dehumidifying a gas stream, which water condenser comprises a condenser inlet for a gas stream to enter the condenser, a first heat exchanger for cooling the gas stream, a condensing surface onto which water from the gas stream can be condensed, a hygroscopic material provided on the condensing surface, and a condenser outlet for a dehumidified gas stream to exit the condenser, wherein the condenser outlet is connected to the thermochemical reactor such that it can provide the reactor with a dehumidified gas stream.

In a further aspect, the invention is directed to a method for desorption in a system of the invention.

In a further aspect, the invention is directed to a method for operating the system of the invention.

The inventors found that by providing a system for thermochemical heat storage with a condenser, the thermochemical material in the thermochemical reactor can be recharged in particular efficient way. The thermochemical material is recharged by contacting it with a gas stream with certain humidity at a certain temperature. The condenser can be used to lower the amount of water in the gas stream before it enters the thermochemical reactor, such that a lower temperature can be used for recharging.

### BRIEF DESCRIPTION OF THE DRAWINGS

FIG. 1 illustrates an embodiment of the system according to the invention. FIG. 1 shows a thermochemical material (TCM), a condenser, an evaporator and four heat exchangers (HX, HR). FIG. 1 further shows the two cycles through which a gas stream can flow through the system; a first loop for charging and discharging the TCM, and a second loop for charging the condenser.

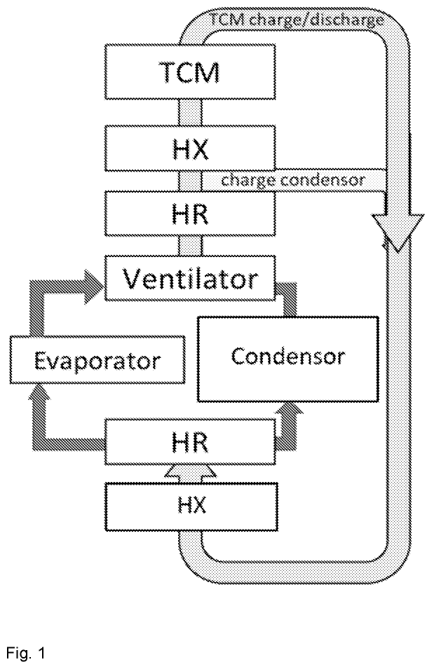

FIG. 2 illustrates an embodiment of the system according to the invention. FIG. 2 shows a thermochemical material (TCM), a condenser that can both function as a condenser and evaporator (condenser/evaporator) and four heat exchangers (HX, HR). FIG. 1 further shows a charging thank for providing water or a hygroscopic salt solution to the condenser.

FIG. 3 illustrates a condenser with a nozzle that can be used to spray either a hygroscopic salt solution (from a salt solution reservoir) or water (from a water reservoir) on the heat exchanging surface of the condenser. This type of condenser can both be used to hydrate and dehydrate a gas stream.

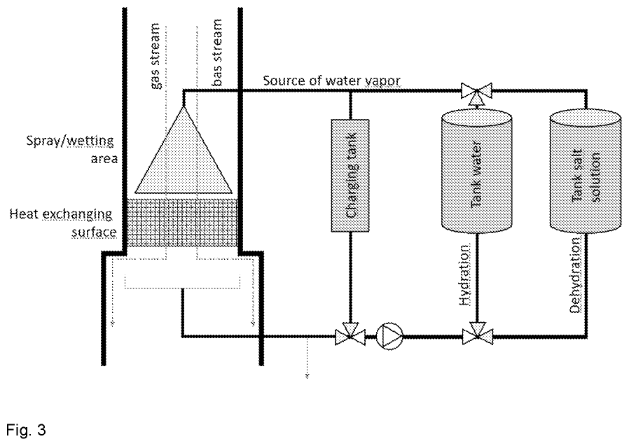

### DETAILED DESCRIPTION

The hygroscopic material (in the condenser) and the thermochemical material (in the thermochemical reactor) are typically different materials. The thermochemical material may be selected from the group consisting of zeolites, silica gel, hygroscopic salts, metal organic frameworks (MOF), carbon and aluminum phosphates. The hygroscopic material may be selected from this same group.

The hygroscopic material provided on the condensing surface may be in liquid form. In this embodiment, the water condenser preferably comprises a nozzle for spraying the liquid hygroscopic material at the condensing surface. Preferably, the condensing surface is the heat exchanging surface of the heat exchanger. Sicj a heat exchanger surface may preferably have fins, which provide an efficient surface for the nozzle to spray on. The condenser may further comprise a first reservoir for storing the liquid hygroscopic material, wherein the reservoir has an outlet connected to the nozzle. The condenser may further have an outlet that allows for used hygroscopic material to be recycled to the first reservoir.

The condenser is able to reduce the water content of a gas stream passing through the condenser. Water vapour present in the gas stream will condense on the condensing surface of the condenser, thus reducing the water content of the gas stream. The condensing surface is typically the heat exchanging surface of the first heat exchanger (i.e. the heat exchanger in the condenser).

In a preferred embodiment, the condenser can not only be used to dehumidify a gas stream, but also to humidify a gas stream. In this case, the condenser can thus function both as a condenser and as an evaporator or humidifier. In this embodiment, the condenser further comprises a water reservoir and an evaporator for evaporating water from the water reservoir and humidifying a gas stream. The heat exchanger may be used as an evaporator. The evaporator may be the first heat exchanger or a second heat exchanger (i.e. a heat exchanger different from the first heat exchanger). The condenser may comprise a nozzle, which can be configured such that it can provide the condenser surface with a liquid hygroscopic material or with water from the water reservoir. Thus, the system can be configured to provide the thermochemical reactor with a humidified gas or with a dehumidified gas from the condenser.

The system can be configured to provide the thermochemical reactor with a humidified gas by using the second heat exchanger to evaporate water or to provide the thermochemical reactor with a dehumidified gas stream by using the first heat exchanger to cool a gas stream.

In case of dehumidification, the heat exchanging surface of the condenser is provided with the liquid hygroscopic material (e.g. by spraying via the nozzle). The water content of a gas stream passing through the condenser will be lowered, because water vapour in the gas stream will condense on the condensing surface (typically on the heat exchanging surface of the first heat exchanger). In case of humidification, the liquid hygroscopic material is preferably removed from the heat exchanging surface of the condenser. This can be done by spraying water or water vapour on the heat exchanging surface. This will remove at least part of the liquid hygroscopic material. Also, it will provide water to increase the water content of the gas stream.

The liquid hygroscopic material may be a hygroscopic solution or a hygroscopic liquid. In case of a hygroscopic solution, the liquid hygroscopic material is preferably a solution of a hygroscopic salt, more preferably an aqueous calcium chloride (CaCl₂) solution, an aqueous lithium chloride (LiCl) solution or an aqueous sodium hydroxide (NaOH) solution. In case of a hygroscopic liquid, the liquid hygroscopic material is preferably glycerin, ethanol or methanol.

The hygroscopic material may also be provided on the condensing surface in solid form. The hygroscopic material is preferably one or more selected from the group of CaCl₂, LiCl, LiBr, Lil, MgCl₂, KOH, NaOH, ZnBr, CH₃CO₂K, silicagel, zeolite and metal organic frameworks (MOF).

The system may further comprise a humidifier for humidifying a gas stream. The humidifier comprises a humidifier inlet for a gas stream to enter the humidifier, a water reservoir, a second heat exchanger for evaporating water from the water reservoir and humidifying a gas stream, a humidifier outlet for a humidified gas stream to exit the humidifier, wherein the humidifier outlet is connected to the thermochemical reactor such that it can provide the reactor with a humidified gas stream.

As explained above, in case of a liquid hygroscopic material, the condenser can function as a humidifier. The water condenser and humidifier may thus be configured such that humidification and condensation can occur in the same vessel, and wherein the nozzle can preferably be configured to spray water for humidifying a gas stream or to spray. However, the humidifier and condenser may also be separate vessels. This is in particular preferred when using a solid hygroscopic material.

In case of a solid hygroscopic material, it may not be possible to use the embodiment described above wherein the condenser can both function as a condenser and an evaporator. The reason for this is that it is difficult to remove and re-apply a solid hygroscopic material on the condensing surface. Not only may spraying a liquid via the nozzle be insufficient to remove a solid hygroscopic material from the condensing surface, but it may also be difficult to provide new solid hygroscopic material on the condensing surface after humidification.

The system can be configured such that the thermochemical reactor can receive a gas stream from the condenser or from the humidifier.

In addition to the first and optional second heat exchanger, the system may comprise one more additional heat exchangers. Such heat exchangers may be for increasing or decreasing the temperature of a gas stream in the system. Preferably, at least one of these additional heat exchanger is configured to increase the temperature of humidified or dehumidified gas stream before entering the thermochemical reactor. These heat exchangers are for controlling the temperature in the system. One may for example be positioned upstream of the thermochemical reactor and downstream of the condenser. Another may be positioned upstream of the condenser (and downstream of the reactor in case the reactor exit is connected to the system inlet). Furthermore, one or more heat exchangers may be present in the system for heat recovery. Such heat exchangers may also be referred to as heat recovery units (HR).

The system is preferably a closed system, wherein the thermochemical reactor comprises an outlet for gas to exit the reactor, which outlet is connected to a system inlet for gas to enter the system, which system inlet is connected to the condenser inlet and, if present, the humidifier inlet. An open system may typically have the same design as closed, except that the outlet of the thermochemical reactor will not be connected to the system inlet and condenser inlet (and humidifier inlet if present).

The system may further comprise a system inlet. The system inlet may be connected to the condenser inlet and/or the humidifier inlet (if present). When operated to dehydrate the TCM, the system inlet will be connected to the condenser inlet, the condenser inlet will be connected to the reactor inlet and the reactor exit will be connected to the system inlet. When operated to hydrate the TCM (to release heat), the system inlet will be connected to the humidifier inlet, the humidifier inlet will be connected to the reactor inlet and the reactor exit will be connected to the system inlet.

The system may comprise a first loop for storing and releasing heat, which loop allows a gas stream to flow from the humidifier or condenser to the thermochemical reactor and then back to the humidifier or condenser. The first loop is preferable a closed loop. During operation, no liquid or gas needs to be added to the system for running multiple sorption and desorption (charging) cycles.

The system may further have a second loop for recharging the hygroscopic material in the condenser, which loop allows a gas stream to be cycled through the condenser without passing the thermochemical reactor in order to dehumidify the hygroscopic material. In this case, the system may comprise an additional heat exchanger or condenser for dehydration of the hygroscopic material.

The system may further comprise a ventilator. A ventilator can regulate the flow of the gas stream through the system.

The term “connected” as used herein typically refers to “fluidly connected”, i.e. a connection that allows a gas stream to pass from one side to the other side of a connection. Such connections may comprise a valve, such that the connection can be opened and closed. Valves may for example be placed in the connections between the condenser and the thermochemical reactor, the humidifier and the condenser, and between the condenser and the system inlet.

As explained above, the system can be configured to switch between different configurations and/or different loops. The system may comprise a number of valves for establishing these configurations and loops. As described above, these may be part of the connections between the different elements of the system.

The system is preferably a system for thermochemical heat storage, more preferably a thermochemical heat battery system.

In another aspect, the invention is directed to a method for desorption in a system according to the invention, comprising a step wherein a gas stream is dehumidified by condensation in the presence of a hygroscopic material, and subsequently feeding the dehumidified gas stream to the thermochemical reactor in order to desorb the thermochemical material.

In another aspect, the invention is directed to a method for heat storage in in a system according to the invention.

The system can be operated at various pressures and temperatures. The system is preferably operated at atmospheric pressure. The system does not require vacuum conditions to efficiently work. Accordingly, the system is operated at a pressure of bar, and is preferably not operated under elevated pressure.

An air stream may be suitable used as the gas stream in the system and method of the invention.

The system is further operated at relatively low temperatures. Desorption of the thermochemical material may be conducted using a gas stream at a temperature below 70° C., preferably at a temperature of 10-60° C.

The invention can decrease the dehydration temperature typically necessary for dehydration of the thermochemical material (TCM). This is inter alia achieved by decreasing the water vapor pressure in the system. The invention thus allows the system to be operated at lower dehydration temperatures. The system includes the addition of a condenser (also sometimes referred as a “dehumidification box”) with hygroscopic material. In case the condenser can also function as humidifier, the condenser may hereinbelow also be referred to as a “(de)humidification box”. The hygroscopic material dehumidifies the gas stream inside the TCM reactor gas loop to allow lower temperature operation to be achieved, active humidification system, the use of two different kinds of salts, and operation under various pressures. The use of the condenser can decrease the charging temperature of the TCM as a result of a lowered water vapor pressure in the gas loop while using the same cold source.

The invention may increase the potential applications of the TCM batteries, as lower temperature sources can be used to charge the batteries. Decreasing the necessarily temperature jump will increase the application field of the TCM. The invention for example allows for the efficient use of TCM batteries in heat pumps (now limited by temperature jumps of +/−35 ° C. with COP>5), solar panels in winter (producing temperatures <80° C.), waste heat of data centres (temperatures of 30-40° C.) and temperature networks (higher ratio of supplied energy can be gathered).

Dehydration of a salt hydrate may only be possible in case the water vapor pressure is below the equilibrium water vapor pressure. This means that dehumidification of the gas stream in a TCM heat battery is needed to perform dehydration (charging) at a lower temperatures.

The present invention works with help of a dehumidification box (condenser) with a hygroscopic material. In general the dehumidification box is a condenser where the water vapor will condense as result of a higher dewpoint than the temperature of the heat exchanger (HX). This means that the dewpoint at the outlet of the HX will typically never be lower than the coolant temperature. Decreasing the coolant temperature can be accomplished with help of a heat pump or other cooling machine, but this costs a lot of energy.

The condenser comprises a heat exchanger and can be configured such that water can condense without blocking the flow path of the heat exchanger. In an embodiment, the (de)humidification box may be a gas/water heat exchanger, where water will be sprayed over. The gas will flow through the heat exchanger, and the water will be sprayed on the fins.

The invention uses the fact that hygroscopic materials can absorb water from the gas, even when the water vapor pressure is lower than the saturated water vapor. For example, salt hydrates can hydrate or deliquescence by water vapor pressures below the saturation water vapor pressure. As a result the water vapor pressure of a gas flow will be lower after passing our dehumidification box filled with a hygroscopic material.

The lower water vapor pressure affects the dehydration of the TCM, such that it can occur at a lower temperature than before (at T_{deh,2} instead of T_{deh,1}). The skilled person will be able to improve the dehydration process in the system by selecting the right hygroscopic material and dehydration temperature. This may result in an increased potential of waste heat sources and/or renewable heat sources and/or high efficient heat sources like HP. The hygroscopic materials can be in solid form (e.g. silicagel, MOF or zeolite) or in liquid form. In case of a liquid hygroscopic material, the material may be a solution of a hygroscopic material (e.g. a hygroscopic salt) in water, or a hygroscopic liquid. The hygroscopic materials can for example be of one of the following three groups:
Group 1 (solid/solid): Silicagel, MOF, zeolite
Group 2 (solid/liquid): CaCl₂, LiCl, LiBr, LiI,
MgCl₂, KOH, NaOH, ZnBr, CH₃CO₂K
Group 3 (liquid/liquid): glycerin, ethanol, methanol, CaCl₂ (aq), LiCl (aq), NaOH (aq)

The material in the low temperature condenser may need to be recharged after use, as the water absorbed will decrease the performance of the dehumidification box. This can be done with help of a low temperature heat source or by outside gas. This may be done inside or outside the TCM cycle.

The invention may be implemented in non-vacuum systems. Closed-loop and open system is possible. Open system may have the same design as closed, excluding the connection between reactor exit (or the HX/2^{nd} condenser if present) and the system inlet.

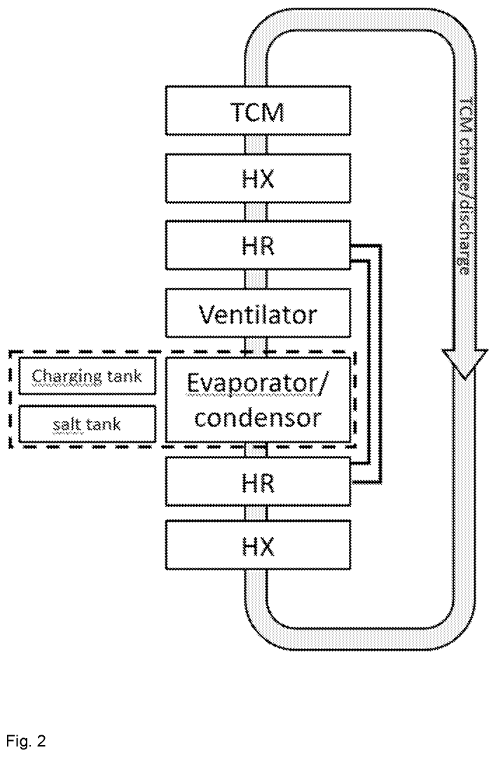

FIG. 2 shows an example of a system according to the invention with the low temperature condenser (i.e., dehumidification box), heat recovery units (HR) and heat exchangers (HX). This closed-loop system according to the invention is drawn in case it the regeneration of the condenser material should be done inside the reactor (then the selected hygroscopic material is a solid like material). With this reactor design it is possible to use the same loop excluding a passage of the TCM reactor to fully recharge the dehumidification box. In the reactor of FIG. 2 we have in the flow direction a heat exchanger (HX) to harvest the heat produced by the TCM. Afterwards the air passes a heat recovery unit (HR). Depending on the mode the air will pass through a condenser or evaporator where the humidity of the air will be decreased or increased, respectively. The air passes the ventilator, and by passing the HR the air will have a higher temperature. A second HX can be used in case the TCM will be charged, in case of discharging the second HX is just passed. Then the air flows through the TCM where the TCM can react with the humid/dry air depending if it is discharging/charging.

In case the low temperature condenser is installed, during charging, the air flow may be dehumidified with the same condenser temperature to a lower humidity as result of the hygroscopic material. This means that the dehydration temperature will be lower than in the situation without the low temperature condenser.

To charge the condenser, the condenser may be heated with one or more internal heat exchangers. An airflow can be passed through the condenser to achieve this. This air flow will not pass the TCM. The air flow may for example be looped to the HR unit, where the air flow will condense on an additional heat exchanger. This recharging can be performed at temperatures a HP has high performance.

### EXAMPLES

The invention will now be further illustrated by the following non-limiting example.

The system of the invention allows for a decrease of the dehydration temperature of a TCM. For dehydration of a material, you need a certain temperature and water vapor pressure. The temperature in a reactor is supplied by a heat exchanger (air/air or air/water), the water vapor pressure is strongly dependent on the temperature in the condenser.

K₂CO₃ is selected as an active material in this example. In case one would want to dehydrate the material, a minimum temperature of 70° C. needs to be applied at the TCM and 20° C. at the condenser side. The condenser is an air/water heat exchanger which will decrease the temperature of the air stream and water vapor will condensate at the heat exchanger.

Using the invention instead of only using the air/water heat exchanger, the condensation process will be improved by spraying a hygroscopic solution at the heat 10 exchanger. This hygroscopic solution decreases the water vapor pressure to a lower value than what should be expected by only water vapor. Three different hygroscopic solutions are compared: CaCl₂(aq); LiCl and NaOH. These solutions have all the potential to lower the water vapor pressure. The higher the concentration of salt is, the lower the water vapor pressure is. For example if a solution of CaCl₂ (0.45 solid fraction) is sprayed over the condenser, at 20° C., the condenser behaves like a temperature of 5° C. is applied. This means that instead of a dehydration temperature of 70° C., only a temperature of 55° C. is needed.

To achieve this, for a heat battery with a power of 1 kW, 1 kg water should condensate in 1 hour. As the CaCl₂ will adsorb the water, the solution will dissolute. This will decrease the performance. In case of a difference of 2 K over one hour in the saturation vapor, the salt solution should not be further diluted than to 0.40 solid fraction. This means that by approximation 10 litre of solution is necessarily to pump around in 1 hour (2.7 I/MJ storage capacity).

To improve the capacity of the condenser solution, the solution has to be regenerated. This is possible by drying the solution. Depending on the outside conditions, the solution can be generated in open air. Therefore the relative humidity in the air stream should be lower than 37%. This strongly depends on the climatic conditions if this is common or not. In case this is not common the solution can be heated to dehydrate in open air.

As can be seen in the table below, depending on the condenser solution the dehydration temperature can be adapted. Selecting the solution affects the dehydration temperature, but also the regeneration RH of the condenser solution. This will affect the overall performance of the battery.

| | Comparative | Invention | Invention | Invention |
|---|---|---|---|---|
| TCM | K₂CO₃ | K₂CO₃ | K₂CO₃ | K₂CO₃ |
| Condenser | Water | CaCl₂ (0.45 | LiCl (0.45 | NaOH (0.45 |
| solution | | solid | solid | solid |
| | | fraction) | fraction) | fraction) |
| Dehydration | 70° C. | 55° C. | 46° C. | 30° C. |
| temperature | | | | |
| Condenser | 20° C. | 20° C. | 20° C. | 20° C. |
| temperature | | | | |
| Regeneration RH | — | 37% | 20% | 8% |

1. A system for thermochemical storage comprising
a thermochemical reactor comprising a thermochemical material capable of storing and releasing heat by a thermochemical exchange process under release or binding of water; and
a water condenser for dehumidifying a gas stream, comprising
a condenser inlet for a gas stream to enter the condenser,
a first heat exchanger for cooling the gas stream,
a condensing surface onto which water from the gas stream can be condensed,
a hygroscopic material provided on the condensing surface, and
a condenser outlet for a dehumidified gas stream to exit the condenser, wherein the condenser outlet is connected to the thermochemical reactor such that it can provide the reactor with a dehumidified gas stream.

2. The system according to claim 1, wherein the hygroscopic material and the thermochemical material are different materials.

3. The system according to claim 1, wherein the thermochemical material and/or the hygroscopic material is selected from the group consisting of zeolites, silica gel, hygroscopic salts, metal organic frameworks (MOF), carbon and aluminum phosphates.

4. The system according to claim 1, wherein the hygroscopic material provided on the condensing surface is in liquid form, and wherein the water condenser further comprises a nozzle for spraying the liquid hygroscopic material at the condensing surface.

5. The system according to claim 4, wherein the condenser further comprises a first reservoir for storing the liquid hygroscopic material, wherein the reservoir has an outlet connected to the nozzle, and wherein preferably the condenser has an outlet that allows used hygroscopic material to be recycled to the first reservoir.

6. The system according to claim 4, wherein the liquid hygroscopic material is a hygroscopic solution or hygroscopic liquid,
wherein the hygroscopic solution is preferably a solution of a hygroscopic salt, more preferably an aqueous calcium chloride (CaCl₂) solution, an aqueous lithium chloride (LiCl) solution or an aqueous sodium hydroxide (NaOH) solution, and
wherein the hygroscopic liquid is preferably glycerin, ethanol or methanol.

7. The system according to any of claim 1, wherein the hygroscopic material is provided on the condensing surface in solid form, and wherein the hygroscopic material is preferably one or more selected from the group of CaCl₂, LiCl, LiBr, LiI, MgCl₂, KOH, NaOH, ZnBr, CH₃CO₂K, silicagel, zeolite and metal organic frameworks (MOF).

8. The system according to claim 1, further comprising
a humidifier for humidifying a gas stream, comprising
a humidifier inlet for a gas stream to enter the humidifier,
a water reservoir,
an evaporator for evaporating water from the water reservoir and humidifying a gas stream,
a humidifier outlet for a humidified gas stream to exit the humidifier, wherein the humidifier outlet is connected to the thermochemical reactor such that it can provide the reactor with a humidified gas stream.
wherein the system can be configured such that the thermochemical reactor can receive a gas stream from the condenser or from the humidifier.

9. The system according to claim 4, wherein the condenser can also function as a humidifier for humidifying a gas stream in the system, wherein the condenser further comprises
a water reservoir,
an evaporator for evaporating water from the water reservoir and humidifying a gas stream, wherein the evaporator may be the first or a second heat exchanger,
wherein the system can be configured to provide the thermochemical reactor with a humidified gas or with a dehumidified gas from the condenser.

10. The system according to claim 9, wherein the condenser comprises a nozzle for spraying a liquid at the condensing surface, wherein the nozzle is configured such that it can provide the condenser surface with a liquid hygroscopic material or with water from the water reservoir.

11. The system according to claim 1, wherein, in addition to the first and optional second heat exchanger, the system comprises one more additional heat exchangers for increasing or decreasing the temperature of a gas stream in the system, and wherein preferably at least one of these additional heat exchanger is configured to increase the temperature of humidified or dehumidified gas stream before entering the thermochemical reactor.

12. The system according to claim 1, wherein the condensing surface is the same surface as the heat exchanging surface of the first heat exchanger.

13. The system according to claim 1, wherein the system is a closed system,
wherein the thermochemical reactor comprises an outlet for gas to exit the reactor, which outlet is connected to a system inlet for gas to enter the system, which system inlet is connected to the condenser inlet and, if present, the humidifier inlet.

14. The system according to claim 1, wherein the system comprises
a first loop for storing and releasing heat, which loop allows a gas stream to flow from the humidifier or condenser to the thermochemical reactor and then back to the humidifier or condenser, and
a second loop for recharging the hygroscopic material in the condenser, which loop allows a gas stream to be cycled through the condenser without passing the thermochemical reactor in order to dehumidify the hygroscopic material.

15. A method for desorption in a system for thermochemical storage, comprising
providing the system recited in claim 1,
performing a step wherein a gas stream is dehumidified by condensation in the presence of a hygroscopic material, and subsequently feeding the dehumidified gas stream to the thermochemical reactor in order to desorb the thermochemical material.
